(19) United States
(12) Patent Application Publication
(10) Pub. No.: US 2009/0015778 A1
(43) Pub. Date: Jan. 15, 2009

(54) LIQUID CRYSTAL DISPLAY AND MANUFACTURING METHOD THEREOF

(75) Inventors: Ju-Sung CHO, Gwangyang-si (KR); Moon-Shik KANG, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 11/968,704

(22) Filed: Jan. 3, 2008

(30) Foreign Application Priority Data
Jul. 13, 2007 (KR) 10-2007-0070568

(51) Int. Cl. G02F 1/13

(52) U.S. Cl. 349/152; 361/771; 445/24

(57) ABSTRACT

The present invention is related to a liquid crystal display (“LCD”) and a method thereof. The LCD includes a liquid crystal (“LC”) panel assembly including a plurality of pixels, a backlight unit providing light to the LC panel assembly, a printed circuit board (“PCB”) mounted with a plurality of circuit elements that control the backlight unit and includes a plurality of pads connected to the backlight unit, and a plurality of metal pieces attached to the pads. The metal pieces are attached when mounting the circuit elements.

This application claims priority to Korean Patent Application No. 10-2007-0070568, filed on Jul. 13, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display (“LCD”) and a method for manufacturing the same. More particularly, the present invention relates to an LCD having a printed circuit board (“PCB”) used for an inverter of a backlight assembly, and a method for manufacturing the LCD.

(b) Description of the Related Art

A liquid crystal display (“LCD”) is one of the most widely used flat panel displays. The LCD includes two display panels each having field-generating electrodes such as pixel electrodes and a common electrode, and a liquid crystal (“LC”) layer interposed therebetween. The LCD induces an electric field on the LC layer by applying a voltage to the field-generating electrodes, determines the alignment of LC molecules in the LC layer therethrough, and controls the polarization of incident light, thereby displaying an image.

The LCD also includes switching elements connected to the pixel electrodes, and a plurality of signal lines such as gate lines and data lines in order to supply data voltages to the pixel electrodes by controlling the switching elements.

Generally, the LCD is a non-emissive device that does not emit light by itself, so it includes a backlight unit. The backlight unit includes light sources, and guides the light from the light sources thereby improving the luminance of the light for providing light to an LC panel assembly. Here, in order to supply power to the light sources for driving the light sources, the backlight unit also includes an inverter. The inverter converts a direct current (“DC”) input voltage into an alternating current (“AC”) voltage and applies the AC voltage to the light sources.

The printed circuit board (“PCB”) used for the inverter includes a plurality of diverse circuits mounted therein. The PCB for the inverter may be a single-side PCB or a double-side PCB, and the PCB having both printed surfaces is generally used.

### BRIEF SUMMARY OF THE INVENTION

It has been determined herein that the production cost of a printed circuit board (“PCB”) including both printed surfaces is relatively increased due to a plating problem of the pad portion of the PCB. The present invention thus reduces the production cost of a printed circuit board (“PCB”) used for an inverter for supplying power to light sources of a liquid crystal display (“LCD”), as well as for increasing reliability thereof.

The present invention also provides a method of manufacturing the LCD.

An LCD according to exemplary embodiments of the present invention includes a liquid crystal (“LC”) panel assembly including a plurality of pixels, a backlight unit that provides light to the LC panel assembly, a PCB mounted with a plurality of circuit elements that control the backlight unit, the PCB including a plurality of pads connected to the backlight unit, and a plurality of metal pieces attached to the pads. The metal pieces may be attached when mounting the circuit elements.

The metal pieces may include tin. The PCB may be a single-side PCB. The PCB may include CEM1, a composite type of laminate material bonded with a flame retardant epoxy resin. The circuit elements may include an inverter that supplies driving power to the backlight unit.

Each metal piece may be a substantially plated shaped element separate from the pads prior to attachment to the pads. A flat surface of each of the metal pieces may be placed in a face to face relationship with each of the pads, respectively. Each of the metal pieces may be respectively soldered to each of the pads.

According to exemplary embodiments of the present invention, a method for manufacturing an LCD including an LC panel assembly, a backlight unit that provides light to the LC panel assembly, a PCB that controls the backlight unit, and a plurality of pads provided on the PCB and connected to the backlight unit, includes mounting a plurality of circuit elements that control the backlight unit on the PCB, and attaching a plurality of metal pieces to the pads of the PCB.

Mounting the circuit elements and attaching the metal pieces may be substantially simultaneously executed.

The metal pieces may include tin. The circuit elements may include an inverter that supplies the driving power to the backlight unit. The circuit elements may include a transformer.

The metal pieces may be attached to the pads by soldering.

The PCB may be a single-side PCB. The PCB may include CEM1, a composite type of laminate material bonded with a flame retardant epoxy resin.

The metal pieces may each include a plate-shaped piece of metal, and attaching the plurality of metal pieces to the pads may include respectively arranging each plate-shaped piece of metal in a face to face relationship with each pad and subsequently securing the plurality of metal pieces to the pads. Securing the plurality of metal pieces to the pads may include soldering the plurality of metal pieces to the pads. Securing the plurality of metal pieces to the pads may be performed substantially simultaneously with mounting the plurality of circuit elements on the PCB.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view of an exemplary liquid crystal display (“LCD”) according to an exemplary embodiment of the present invention;

FIG. 2 is a block diagram of an exemplary LCD according to an exemplary embodiment of the present invention;

FIG. 3 is an equivalent circuit diagram of an exemplary pixel of the exemplary LCD shown in FIG. 2;

FIG. 4 is a plan view showing an exemplary printed circuit board (“PCB”) of an exemplary LCD according to an exemplary embodiment of the present invention; and,

FIG. 5 is a cross-sectional view of the exemplary PCB shown in FIG. 4 taken along line V-V.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

A display device according to an exemplary embodiment of the present invention will be described in detail with reference to the accompanying drawings.

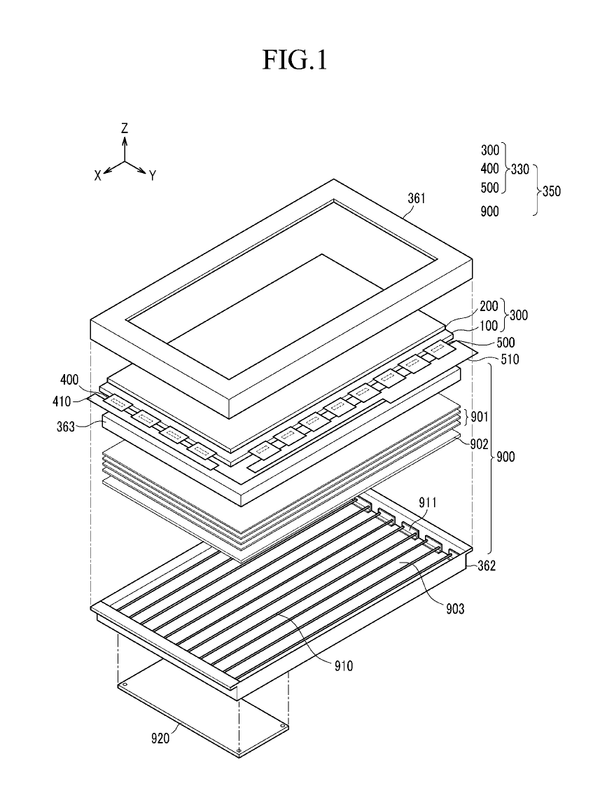

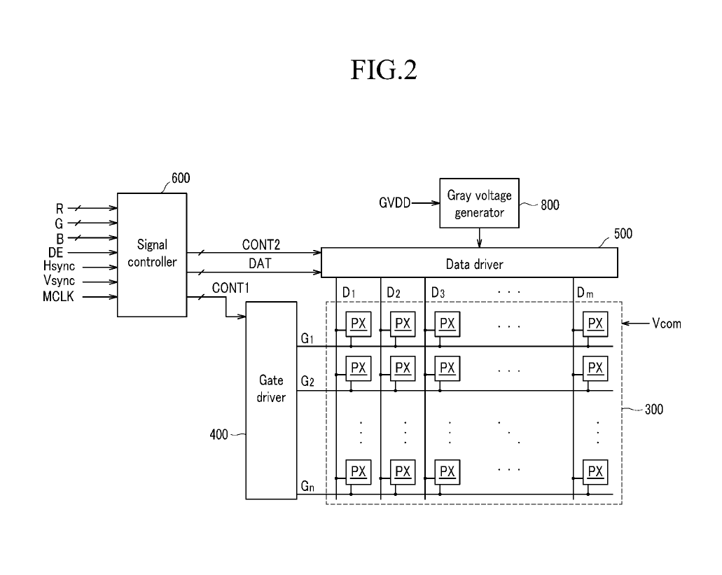

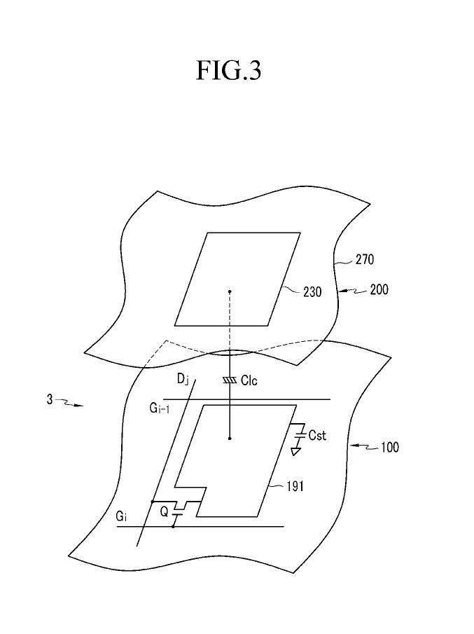

FIG. 1 is an exploded perspective view of an exemplary liquid crystal display (“LCD”) according to an exemplary embodiment of the present invention, FIG. 2 is a block diagram of an exemplary LCD according to an exemplary embodiment of the present invention, and FIG. 3 is an equivalent circuit diagram of an exemplary pixel of the exemplary LCD shown in FIG. 2.

Referring to FIG. 1, a display device according to an exemplary embodiment of the present invention includes a liquid crystal (“LC”) module 350 having a display panel 330 and a backlight unit 900, upper and lower chassis 361 and 362 receiving the LC module 350, and a molded frame 363.

The display panel 330 includes an LC panel assembly 300, a gate driver 400, a data driver 500, a first printed circuit board (“PCB”) 410, and a second PCB 510, which are attached to the LC panel assembly 300. The first PCB 410 and the second PCB 510 may be flexible PCBs.

In the block diagram shown in FIG. 2, the LC panel assembly 300 includes a plurality of signal lines G1-Gn and D1-Dm, and a plurality of pixels PX. In the structural view shown in FIG. 3, the LC panel assembly 300 includes lower and upper panels 100 and 200 facing each other, and an LC layer 3 interposed between the panels 100 and 200. The signal lines G1-Gn and D1-Dm may be formed on the lower panel 100.

The signal lines include a plurality of gate lines G1-Gn transmitting gate signals (also referred to as “scanning signals” hereinafter) and a plurality of data lines D1-Dm transmitting data voltages. The gate lines G1-Gn extend substantially in a row direction, such as a first direction, and substantially parallel to each other, while the data lines D1-Dm extend substantially in a column direction, such as a second direction, and substantially parallel to each other. The first and second directions may be substantially perpendicular to each other.

The pixels PX are arranged substantially in a matrix. Referring to FIG. 3, each pixel PX, for example a pixel PX connected to an i-th gate line Gᵢ (i=1, 2, . . . , n) and a j-th data line Dⱼ (j=1, 2, . . . , m), includes a switching element Q connected to the signal lines Gᵢ and Dⱼ, and an LC capacitor Clc and a storage capacitor Cst that are connected to the switching element Q. The switching element Q may be a thin film transistor (“TFT”). In some exemplary embodiments, the storage capacitor Cst may be omitted.

The switching element Q is disposed on the lower panel 100 and has three terminals, i.e., a control terminal, such as a gate electrode, connected to the gate line Gᵢ, an input terminal, such as a source electrode, connected to the data line Dⱼ, and an output terminal, such as a drain electrode, connected to the LC capacitor Clc and the storage capacitor Cst.

The LC capacitor Clc includes a pixel electrode 191 disposed on the lower panel 100 and a common electrode 270 disposed on the upper panel 200 as two terminals. The LC layer 3 disposed between the two electrodes 191 and 270 functions as a dielectric of the LC capacitor Clc. The pixel electrode 191 is connected to the output terminal of the switching element Q, and the common electrode 270 is supplied with a common voltage Vcom and covers an entire surface, or substantially an entire surface, of the upper panel 200.

The storage capacitor Cst is an auxiliary capacitor for the LC capacitor Clc. The storage capacitor Cst includes the pixel electrode 191 and a separate signal line, which is provided on the lower panel 100, overlaps the pixel electrode 191 via an insulator, and is supplied with a predetermined voltage such as the common voltage Vcom.

For color display, each pixel uniquely represents one color in a set of colors, such as primary colors (i.e., spatial division) or each pixel sequentially represents the colors in the set of colors in turn (i.e., temporal division) such that a spatial or temporal sum of the colors is recognized as a desired color. An example of the set of colors includes red, green, and blue colors. FIG. 3 shows a color filter 230 formed on the upper panel 200.

One or more polarizers (not shown) may be attached to the LC panel assembly 300. In an exemplary embodiment, a first polarized film and a second polarized film are disposed on the lower panel 100 and the upper panel 200, respectively. The first and second polarized films adjust a transmission direction of light externally provided in the lower panel 100 and the upper panel 200, respectively, in accordance with an aligned direction of the liquid crystal layer 3. The first and second polarized films may have first and second polarized axes thereof substantially perpendicular to each other.

Referring to FIG. 1 and FIG. 2 again, the LCD according to the present exemplary embodiment includes the LC panel assembly 300, the gate driver 400, the data driver 500, and a gray voltage generator 800, which are connected to the LC panel assembly 300, and a signal controller 600 for controlling these elements.

The gray voltage generator 800 generates a full number of gray voltages or a limited number of gray voltages (referred to as “reference gray voltages” hereinafter) related to the transmittance of the pixels PX.

The gate driver 400 is connected to the gate lines G1-Gn of the LC panel assembly 300, and synthesizes a gate-on voltage Von and a gate-off voltage Voff to generate the gate signals for application to the gate lines G1-Gn and to the control terminal of the switching element Q of each pixel PX.

The data driver 500 is connected to the data lines D1-Dm of the LC panel assembly 300 and applies data voltages, which are selected from the gray voltages supplied from the gray voltage generator 800, to the data lines D1-Dm and to the input terminal of the switching element Q of each pixel PX. However, when the gray voltage generator 800 generates only the reference gray voltages rather than all the gray voltages, the data driver 500 may divide the reference gray voltages to generate the data voltages from the reference gray voltages.

The signal controller 600 controls the gate driver 400, the data driver 500, etc.

Further, each of the gate driver 400 and the data driver 500 may be mounted on a flexible printed circuit (“FPC”) film in a tape carrier package (“TCP”) type, which are attached to the LC panel assembly 300. Alternatively, each of the gate driver 400 and the data driver 500 may be directly mounted in at least one integrated circuit (“IC”) chip on the LC panel assembly 300, or may be mounted on an additional PCB (not shown). Alternatively, at least one of the drivers 400 and 500 may be integrated into the LC panel assembly 300 along with the signal lines G1-Gn and D1-Dm and the switching elements Q.

On the other hand, the gate driver 400 and data driver 500 may be respectively connected to the first PCB 410 and the second PCB 510, and respectively receive the gate signals or the data voltages. The first and second PCBs 410 and 510 may be connected to each other, and one of them may be omitted.

The signal controller 600, the gray voltage generator 800, etc., are mounted on the first or second PCB 410 or 510. Alternatively, at least one of the signal controller 600 and gray voltage generator 800 may be integrated into the LC panel assembly 300 along with the signal lines G1-Gn and D1-Dm and the switching elements Q, and may be integrated in a single chip.

Referring to FIG. 1 again, the molded frame 363 wholly supporting the display device is positioned between the upper chassis 361 and the lower chassis 362.

The backlight unit 900 includes light sources 910, an inverter 920, a light guide, such as a light guide plate 902, a reflective sheet 903, and a plurality of optical sheets 901.

The light sources 910 are received between the lower chassis 362 and the molded frame 363, and are fixed to the lower chassis 362 by a holder 911 for supplying light toward the LC panel assembly 300. The light sources 910 may be light emitting diodes (“LED”), line light source types, or planar light source types. Also, while the light sources 910 are illustrated as arranged below the light guide plate 902 and optical sheets 901, the light sources 910 may alternatively be arranged at a side or sides of the light guide plate 902 as in an edge type backlight unit.

An inverter 920 is attached to the rear surface of the lower chassis 362. The inverter 920 converts a voltage that is applied from an external device into a voltage having a predetermined magnitude, and supplies the driving power to the light sources 910. In the illustrated embodiment of FIG. 1, the inverter 920 is attached relative to one side of the light sources 910, but in an alternative exemplary embodiment, another inverter (not shown) may be attached to the other side of the light sources 910.

The light guide plate 902 guides the light from the light sources 910 toward the LC panel assembly 300 and uniformly maintains the intensity of the light.

The reflective sheet 903 is positioned under the light guide plate 902, such as on a bottom surface of the lower chassis 362, and reflects the light from the light sources 910 toward the LC panel assembly 300.

The optical sheets 901 are positioned over the light guide plate 902 and improve luminance characteristics of the light from the light sources 910.

The upper chassis 361 and the lower chassis 362 are combined with the molded frame 363, and receive the LC module 350 therein.

Now, an exemplary operation of the above-described display device will be described in detail.

The signal controller 600 is supplied with input image signals R, G, and B and input control signals for controlling the display thereof from an external graphics controller (not shown). The input image signals R, G, and B contain luminance information of pixels PX, and the luminance has a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

Based on the input control signals and the input image signals R, G, and B, the signal controller 600 generates gate control signals CONT1 and data control signals CONT2, and processes the image signals R, G, and B to be suitable for the operation of the LC panel assembly 300 and the data driver 500. The signal controller 600 sends the gate control signals CONT1 to the gate driver 400 and sends the processed image signals DAT and the data control signals CONT2 to the data driver 500.

Responsive to the data control signals CONT2 from the signal controller 600, the data driver 500 receives a packet of the digital image signals DAT for the row of pixels PX from the signal controller 600, converts the digital image signals DAT into analog data voltages selected from the gray voltages from the gray voltage generator 800, and applies the analog data voltages to the data lines D1-Dm.

The gate driver 400 applies the gate-on voltage Von to each gate line G1-Gn in response to the gate control signals CONT1 from the signal controller 600, thereby turning on the switching transistors Q connected thereto. The data voltages applied to the data lines D1-Dm are then supplied to the pixels PX through the activated switching transistors Q.

The difference between the data voltage and the common voltage Vcom applied to a pixel PX is represented as a voltage across the LC capacitor Clc of the pixel PX, which is referred to as a pixel voltage. LC molecules in the LC layer 3 in the LC capacitor Clc have orientations depending on the magnitude of the pixel voltage, and the molecular orientations determine the polarization of light passing through the LC layer 3. The polarizer(s) converts light polarization to light transmittance such that the pixel PX has a luminance represented by a gray of the data voltage.

By repeating this procedure by a unit of a horizontal period (also referred to as “1H” and that is equal to one period of the horizontal synchronization signal Hsync and the data enable signal DE), all gate lines G₁-Gₙ are sequentially supplied with the gate-on voltage Von, thereby applying the data voltages to all pixels PX to display an image for a frame.

When the next frame starts after one frame finishes, the inversion signal RVS applied to the data driver 500 is controlled such that the polarity of the data voltages is reversed (which is referred to as “frame inversion”). The inversion signal RVS may also be controlled such that the polarity of the data voltages flowing in a data line is periodically reversed during one frame (for example row inversion and dot inversion), or the polarity of the data voltages in one packet is reversed (for example column inversion and dot inversion).

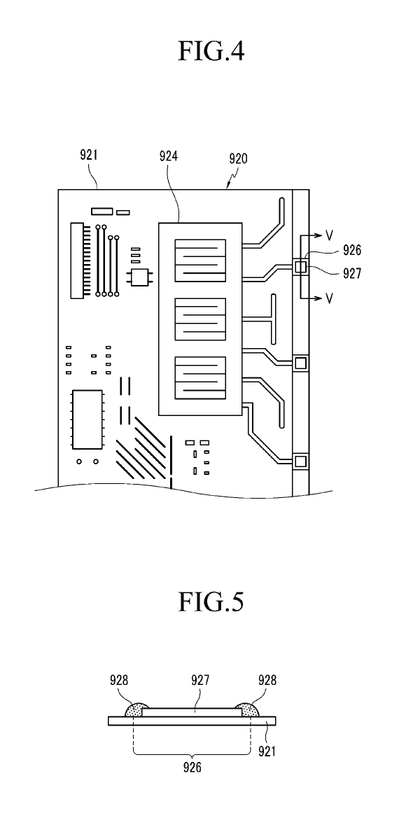

Next, the inverter 920 of the LCD according to an exemplary embodiment of the present invention will be described in detail with reference to FIGS. 4 and 5.

FIG. 4 is a plan view showing an exemplary PCB of an exemplary LCD according to an exemplary embodiment of the present invention, and FIG. 5 is a cross-sectional view of the exemplary PCB shown in FIG. 4 taken along line V-V.

First, with reference to FIG. 4, a plurality of circuit elements such as a transformer 924 are mounted on a third PCB 921 in the inverter 920 according to an exemplary embodiment of the present invention. A plurality of pads 926 electrically connected to the light sources 910 through sockets (not shown) are formed on one side of the inverter 920, and on one side of the third PCB 921. The third PCB 921 may include the circuit elements and the pads 926 on the same surface thereof such that the third PCB 921 is a single side PCB.

A plurality of metal pieces 927 are respectively attached to the pads 926 with solder 928. The metal pieces 927 may be made of a material such as tin. Each metal piece 927 may be substantially plate shaped and is separate element from the pad 926 prior to attachment to the pad 926. For example, each metal piece 927 may include a small metal sheet. As shown in FIG. 5, each metal piece 927 may have a substantially rectangular cross-sectional shape such that a flat surface of the metal piece 927 is in a face to face relationship with the pad 926. The inverter 920 supplies the driving power to the light sources 910 through the pads 926 attached to the metal pieces 927.

The metal pieces 927 are attached during the process for mounting the circuit elements, such as the transformer 924, on the third PCB 921. In other words, when the circuit elements are soldered to the surface of the third PCB 921, the metal pieces 927 are also soldered to the pads 926, such that the metal pieces 927 and the circuit elements may be substantially simultaneously mounted and attached to the third PCB 921.

If the metal pieces 927 are formed using a plating process, then it would be difficult for the metal pieces 927 to be formed during the same process for mounting the circuit elements. That is to say, the plating process of the metal pieces 927 would be executed separately from the mounting of the circuit elements on the third PCB 921.

However, in an exemplary embodiment of the present invention, because the metal pieces 927 are attached to the pads 926 with solder 928 according to an exemplary embodiment of the present invention, instead of using the plating process, the pads 926 may be substantially simultaneously formed along with the mounting process of the circuit elements. Accordingly, the production process of the inverter 920 may be shortened.

Furthermore, if the metal of the pads 926 is formed by plating, then a chemical reaction may be generated between the plated metal of the pads 926 and the third PCB 921 such that the physical and chemical characteristics of the third PCB 921 and the pads 926 may be changed. Accordingly, the material of the third PCB 921 that is adaptable to the inverter 920 is limited such that the cost of the third PCB 921 is increased.

However, because the metal pieces 927 are simply attached on the pads 926 through soldering in an exemplary embodiment of the present invention, the chemical reaction between the third PCB 921 and the metal pieces 927 is not generated, as may occur in a plating process. Accordingly, the material of the third PCB 921 used for the inverter 920 is not limited such that the third PCB 921 has a relatively low cost.

For example, the material of the third PCB 921 is preferably chosen from XPC and FR1 (flame retardant) of a phenol resin type, FR4 of an epoxy resin type, and CEM1 (composite type of laminate material bonded with a flame retardant epoxy resin) and CEM3 of a composite resin type. If pads 926 are formed by tin plating, due to reliability thereof, then it would be preferable that the third PCB 921 is made of FR4 and CEM3 among various materials to minimize the changes of the characteristics of the materials. However, the cost thereof is relatively high such that the production cost of the inverter 920 would be increased. Conversely, CEM1 has good material characteristics and a low cost, but there is a concern that the chemical reaction may be generated during the tin plating of the pads 926 such that the use of CEM1 is impossible.

In the exemplary embodiment of the present invention, however, the plating process for the pads 926 is not executed such that changes of the characteristics of the third PCB 921 and the pads 926 are hardly generated when using CEM1 having a relatively low cost. CEM1 that is used as a single-side PCB is made of a compound having a paper core in which an epoxy resin is permeated and included. Thus, the cost of the third PCB 921 used in the inverter 920 may be reduced, thereby minimizing the production cost of the inverter 920 in the exemplary embodiment of the present invention.

According to the present invention, good reliability of the inverter for supplying power to the backlight unit of the LCD may be obtained, the manufacturing process may be simplified, and the production cost may be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a liquid crystal panel assembly comprising a plurality of pixels;
a backlight unit that provides light to the liquid crystal panel assembly;
a printed circuit board mounted with a plurality of circuit elements that control the backlight unit, the printed circuit board comprising a plurality of pads connected to the backlight unit; and
a plurality of metal pieces attached to the pads.

2. The liquid crystal display of claim 1, wherein
the metal pieces are attached when mounting the circuit elements.

3. The liquid crystal display of claim 1, wherein
the metal pieces comprise tin.

4. The liquid crystal display of claim 1, wherein
the printed circuit board comprises a single-side printed circuit board.

5. The liquid crystal display of claim 1, wherein
the printed circuit board comprises CEM1, a composite type of laminate material bonded with a flame retardant epoxy resin.

6. The liquid crystal display of claim 1, wherein
the circuit elements comprise an inverter that supplies driving power to the backlight unit.

7. The liquid crystal display of claim 1, wherein each of the metal pieces is a substantially plate shaped element separate from the pads prior to attachment to the pads.

8. The liquid crystal display of claim 1, wherein a flat surface of each of the metal pieces is placed in a face to face relationship with each of the pads, respectively.

9. The liquid crystal display of claim 1, wherein each of the metal pieces is respectively soldered to each of the pads.

10. A method for manufacturing a liquid crystal display including a liquid crystal panel assembly, a backlight unit that provides light to the liquid crystal panel assembly, a printed circuit board that controls the backlight unit, and a plurality of pads provided on the printed circuit board and connected to the backlight unit, the method comprising:
mounting a plurality of circuit elements that control the backlight unit on the printed circuit board; and
attaching a plurality of metal pieces to the pads of the printed circuit board.

11. The method of claim 10, wherein
mounting the circuit elements and attaching the metal pieces are substantially simultaneously executed.

12. The method of claim 10, wherein
the metal pieces comprise tin.

13. The method of claim 10, wherein
the circuit elements comprise an inverter that supplies driving power to the backlight unit.

14. The method of claim 10, wherein
the metal pieces are attached to the pads by soldering.

15. The method of claim 10, wherein
the printed circuit board comprises a single-side printed circuit board.

16. The method of claim 15, wherein
the printed circuit board comprises CEM1, a composite type of laminate material bonded with a flame retardant epoxy resin.

17. The method of claim 10, wherein the metal pieces each include a plate-shaped piece of metal, wherein attaching the plurality of metal pieces to the pads includes respectively arranging each plate-shaped piece of metal in a face to face relationship with each pad and subsequently securing the plurality of metal pieces to the pads.

18. The method of claim 17, wherein securing the plurality of metal pieces to the pads includes soldering the plurality of metal pieces to the pads.

19. The method of claim 17, wherein securing the plurality of metal pieces to the pads is performed substantially simultaneously with mounting the plurality of circuit elements on the printed circuit board.

20. The method of claim 10, wherein the circuit elements include a transformer.
